(19) United States
(12) Patent Application Publication
(10) Pub. No.: US 2006/0152530 A1
(43) Pub. Date: Jul. 13, 2006

(54) Apparatus to improve digital signal filtering and associated methods

(75) Inventor: Stewart Gresty Smith, Edinburgh (GB)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: STMicroelectronics Ltd., Marlow - Buckinghamshire (GB)

(21) Appl. No.: 11/325,112

(22) Filed: Jan. 4, 2006

(30) Foreign Application Priority Data
Jan. 11, 2005 (EP) 05250101.2

(51) Int. Cl. G09G 5/00

(52) U.S. Cl. 345/611

(57) ABSTRACT

A digital filter is provided that may replace a center pixel with the nearest-valued opposing average. The filter may reduce the amplitude of a defective pixel couplet by at least 50%, and may structure noise into linear artifacts.

### FIELD OF THE INVENTION

The invention relates to an apparatus and method for digital filtering of a signal, and, in particular to a signal relating to an image.

### BACKGROUND OF THE INVENTION

Generally, the dominant noise sources that affect a CMOS image sensor are random noise (Gaussian), fixed-pattern noise FPN (1-D and 2-D Gaussian, dominated by 1-D column-FPN), and defectivity (low probability, pixels which are stuck-at-white).

However, as feature sizes shrink, different signal degradation mechanisms have an increased significance for CMOS sensors, such as random noise that is not purely Gaussian, and FPN which is 2-D Gaussian with a white quasi-Poisson distribution tail. Furthermore, electrically leaky pixels are more of a problem than pixels that are stuck-at-white. The white distribution tail increases the incidence of couplets (neighbouring defective pixels) as stress on the sensor increases (examples of stresses include gain, temperature and integration time).

Traditionally, defect correction attacks salient pixel defects while noise reduction attacks Gaussian noise. However, as feature sizes shrink and CMOS sensors become sensitive to the different degradation mechanisms mentioned above, these separate tasks are converging, that is, some defect correction techniques have a utility in correcting for noise, and some noise reduction techniques have utility in correcting for pixel defects. However, neither type of technique deals with couplets.

Defect correction can use heavier filtering if targeted at known defects, as opposed to filtering all pixels on-the-fly. However, this requires a defectivity map to be created and maintained, which involves large costs in terms of silicon area and test time. Larger kernel filters for defect correction also present difficulties in implementation, being big in terms of logic, line RAM; difficult to design because multiple RAM read/write (r/w) access per pixel is required; and having a deleterious effect on image quality.

### SUMMARY OF THE INVENTION

According to a first aspect, there is provided a method of filtering a signal that may comprise a plurality of pixel values each of which is obtained from at least one pixel of an image sensing array. The method may comprise obtaining a central pixel value and a plurality of neighboring pixel values, and determining the average value of each opposing pair of pixel values. The method may also comprise comparing each average value with the central pixel value, and replacing the central pixel value with the average value that is closest to the central pixel value.

Preferably, neighboring pixel values may be derived from neighboring pixels. Preferably, the outputs obtained from the application of the method to a first central pixel value may be used as the inputs for the application of the method to a second pixel value. This recursive method may provide a greater attenuation of defective pixel couplets.

Preferably, the second pixel value may be a neighboring pixel value of the first pixel value. Preferably, the method may be applied to a set of defective pixel couplets in an image.

Preferably, the method may be selectively applied to pixel values that are above or below a predetermined threshold. Preferably, the predetermined threshold may be varied to select a level of filtering severity.

According to a second aspect, there is provided an apparatus for filtering a signal that may comprise a plurality of pixel values each of which is obtained from at least one pixel of an image sensing array. The apparatus may comprise a reading unit or read means for obtaining a central pixel value and a plurality of neighboring pixel values. The apparatus may also comprise a calculator or calculation means for determining the average value of each opposing pair of pixel values, comparing each average value with the central pixel value, and replacing the central pixel value with the average value that is closest to the central pixel value.

Preferably, neighboring pixel values may be derived from neighboring pixels. Preferably, the apparatus may further comprise a memory or memory means to store the outputs obtained from a first central pixel value, and the outputs forming the inputs for the calculator or calculation means when the apparatus operates on a second pixel value. This recursive method may provide a greater attenuation of defective pixel couplets.

Preferably, the second pixel value may be a neighboring pixel value of the first pixel value. Preferably, the apparatus may be arranged to operate on a set of defective pixel couplets in an image.

Preferably, the apparatus may further comprises a selector or means to select pixel values which are above or below a predetermined threshold for operation on by the apparatus. Preferably, the predetermined threshold may be varied to select a level of filtering severity.

According to a third aspect, there is provided a CMOS image sensor that may comprise the apparatus of the second aspect. According to further aspects, there is provided a digital camera, an optical mouse, or a mobile phone comprising a digital camera, which may comprise the CMOS image sensor of the third aspect.

### BRIEF DESCRIPTION OF THE DRAWINGS

The invention will now be described, by way of example only, with reference to the accompanying drawings, in which:

FIG. 1 illustrates the logical structure of a digital filter in accordance with the invention; and

FIGS. 2a and 2b illustrate non-recursive and recursive operations of the filter shown in FIG. 1.

### DETAILED DESCRIPTION OF THE PREFERRED EMBODIMENTS

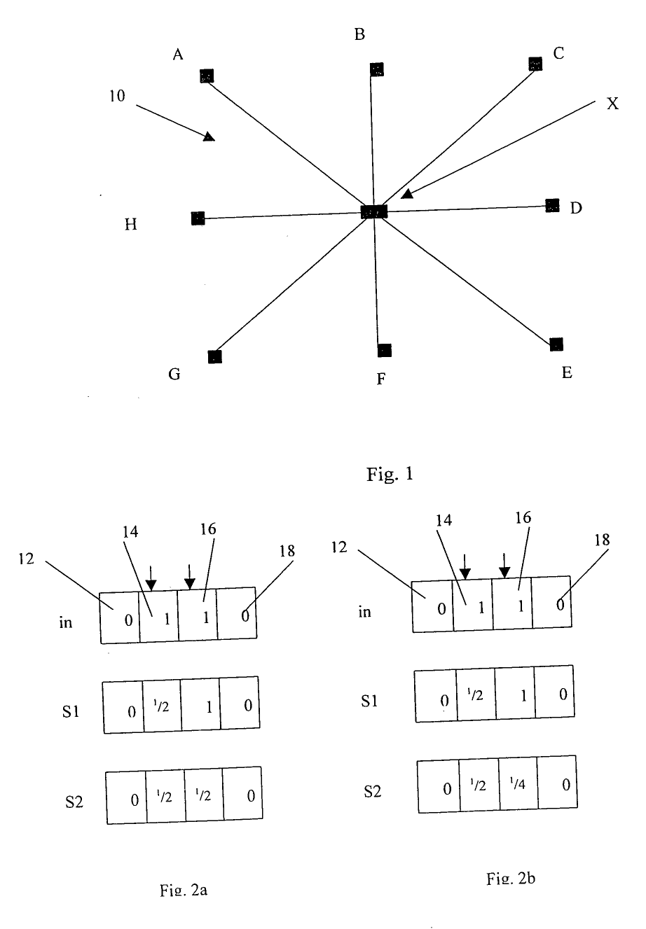

FIG. 1 illustrates the logical structure of a digital filter 10 that is applied to a series of pixel values derived from corresponding pixel sites in an image sensing array. The filter 10 operates to replace a central value, X, with a replacement value based on the values of its neighbors A-H, as follows. The central pixel value X can be considered to have a number of opposing pairs of neighbors, that is two neighbors which are on opposite sides of the central pixel value in a horizontal, vertical or diagonal direction. The filter of FIG. 1 has four different opposing pairs, namely A and E, B and F, C and G, and D and H.

The filter of FIG. 1 calculates the average of each opposing pair of pixel values, compares each value with the central pixel value X, and then chooses the closest average as the replacement value for the central pixel value. In a preferred embodiment, neighboring pixel values to which the filter 10 is applied correspond to neighboring pixel sites on an image sensing array. The filter can be implemented in a recursive or a non-recursive manner, as illustrated in FIGS. 2a and 2b, which illustrates how a series of pixel values 12, 14, 16, 18 change as a filter moves to the right and in which the horizontally opposed neighbors (H and D in FIG. 1) give the values for the replacement value of a central pixel value.

FIG. 2a shows a non-recursive filter operation. An input line (in) has a series of pixel values, shown as 0,1,1,0. The pixel value 14 is chosen as the central value such that after a first step (s1), the central pixel value 14 is replaced by the average of its two neighbors 12 and 16. That is, the value “1” is replaced by the average of “0” and “1”, thus becoming “½”.

The filter then moves to the right, such that pixel value 16 becomes the central pixel value. After a second step (s2), the central pixel value 16 of the original input (in) is replaced by the average of its two neighbors 14 and 18. That is, the value “1” is replaced by the average of “1” and “0”, thus becoming “½”.

FIG. 2b shows a recursive filter operation, in which the outputs from a first step form the inputs for the next step. Starting from the same input (in), the pixel value 14 is chosen as the central value, such that after a first step (s1), the central pixel value 14 is replaced by the average of its two neighbors 12, 16. That is, the value “1” is replaced by the average of “0” and “1”, thus becoming “½”.

The filter then moves to the right, such that pixel value 16 becomes the central pixel value. After a second step (s2), the central pixel value 16 is replaced by the average of its two neighbors 14, 18 as defined after the first step (s1). That is, the value “1” is replaced by the average of “½” and “0”, thus becoming “¼”.

It can be seen that a non-recursive operation on a pixel couplet 14, 16 attenuates the couplet, reducing its value by half in the example shown. The recursive operation results in a further attenuation, but has a more significant effect on the image than that resulting from the non-recursive operation.

The operation of the filter can be controlled by a feedback loop that monitors the effects of the filter and adjusts its application accordingly. When used in a digital camera, a camera control system can be provided which evaluates the effect the filter has on the image and adjusts the filter operation accordingly.

The filter could simply be switched on or off, or alternatively could be set to apply filtering to values that fall a predetermined amount above or below specific signal thresholds. The predetermined amount could be varied to provide a “fader” allowing an operating system to quantifiably vary the strength of filtering applied based upon the preferred balance between defect correction and image destruction.

The filter provides a number of advantages over prior art filters. Firstly, the filter can be specifically targeted at pixel couplets by being effective to significantly reduce their amplitude, for example. Noise is structured into linear artifacts for further processing by other noise reduction techniques. Furthermore, the logic cost is small, and there is no history requirement.

It will be appreciated that the digital filter could be used in image sensors for a wide range of applications, including digital cameras, mobile telephones with digital cameras, or optical mice to name but a few examples. The practical issues regarding implementation of the digital filter to any of these devices will be readily apparent to those skilled in the art, and so a detailed description thereof is not necessary herein. Improvements and modifications can be made to the above without departing from the scope of the invention.

1-16. (canceled)

17. A method of filtering a signal comprising a plurality of pixel values each of which is obtained from at least one pixel of an image sensing array, the method comprising:
obtaining a central pixel value and a plurality of neighboring pixel values;
determining an average value of each opposing pair of neighboring pixel values;
comparing each average value with the central pixel value; and
replacing the central pixel value with the average value that is closest to the central pixel value.

18. The method according to claim 17 wherein the neighboring pixel values are derived from neighboring pixels.

19. The method according to claim 17 wherein the average value that is closest to the central pixel value is used as input for the application of the method for a second pixel value.

20. The method according to claim 19 wherein the second pixel value comprises a neighboring pixel value of the central pixel value.

21. The method according to claim 19 wherein the central pixel value and the second pixel value comprise a defective pixel couplet in an image.

22. The method according to claim 17 further comprising selectively applying the determining, comparing, and replacing to central pixel values above or below a threshold.

23. The method according to claim 22 further comprising setting the threshold to select a desired level of filtering.

24. An apparatus for filtering a signal comprising a plurality of pixel values each of which is obtained from at least one pixel of an image sensing array, the apparatus comprising:
a reading unit for obtaining a central pixel value and a plurality of neighboring pixel values; and
a calculator for
determining an average value of each opposing pair of neighboring pixel values,
comparing each average value with the central pixel value, and
replacing the central pixel value with the average value that is closest to the central pixel value.

25. The apparatus according to claim 24 wherein and the neighboring pixel values are derived from neighboring pixels.

26. The apparatus according to claim 24 further comprising a memory for storing the average value that is closest to the central pixel value; and wherein said calculator uses the average value that is closest to the central pixel value as an input when operating on a second pixel value.

27. The apparatus according to claim 26 wherein the second pixel value is a neighboring pixel value of the central pixel value.

28. The apparatus according to claim 26 wherein the central pixel value and the second pixel value comprise a defective pixel couplet in an image.

29. The apparatus according to claim 24 further comprising a selector for selecting central pixel values which are above or below a threshold.

30. The apparatus according to claim 29 wherein the threshold is settable to select a desired level of filtering.

31. The apparatus according to claim 24 wherein the apparatus comprises a CMOS image sensor.

32. The apparatus according to claim 31 wherein the CMOS image sensor comprises at least one of an optical mouse, a mobile phone, and a digital camera.

33. An apparatus for filtering a signal comprising a plurality of pixel values each of which is obtained from at least one pixel of an image sensing array, the apparatus comprising:
a reading unit for obtaining a central pixel value and a plurality of neighboring pixel values;
a selector for selecting the central pixel value and a plurality of neighboring pixel values which are above or below a threshold;
a calculator for
determining an average value of each opposing pair of neighboring pixel values,
comparing each average value with the central pixel value, and
replacing the central pixel value with the average value that is closest to the central pixel value; and
a memory for storing the average value that is closest to the central pixel value.

34. The apparatus according to claim 33 wherein the neighboring pixel values are derived from neighboring pixels.

35. The apparatus according to claim 33 wherein said calculator uses the average value that is closest to the central pixel value as an input when operating on a second pixel value.

36. The apparatus according to claim 35 wherein the second pixel value is a neighboring pixel value of the central pixel value.

37. The apparatus according to claim 35 wherein the central pixel value and the second pixel value comprise a defective pixel couplet in an image.

38. The apparatus according to claim 33 wherein the threshold is settable to select a desired level of filtering.

39. The apparatus according to claim 33 wherein the apparatus comprises a CMOS image sensor.

40. The apparatus according to claim 39 wherein the CMOS image sensor comprises at least one of an optical mouse, a mobile phone, and a digital camera.
